(19) United States
(12) Patent Application Publication
(10) Pub. No.: US 2024/0357247 A1
(43) Pub. Date: Oct. 24, 2024

(54) IMAGE PROCESSING SYSTEM, MOVING OBJECT, IMAGING SYSTEM, IMAGE PROCESSING METHOD, AND STORAGE MEDIUM

(71) Applicant: CANON KABUSHIKI KAISHA, Tokyo (JP)

(72) Inventor: KEISUKE KOBAYASHI, Tokyo (JP)

(21) Appl. No.: 18/760,446

(22) Filed: Jul. 1, 2024

Related U.S. Application Data
(63) Continuation-in-part of application No. PCT/JP2023/001931, filed on Jan. 23, 2023.

(30) Foreign Application Priority Data
Jan. 26, 2022 (JP) 2022-010443
Jan. 6, 2023 (JP) 2023-001011

(51) Int. Cl. H04N 23/951; B60R 1/27; H04N 23/69

(52) U.S. Cl. CPC H04N 23/951; H04N 23/69; B60R 1/27; B60R 2300/105; B60R 2300/303; B60R 2300/607

(57) ABSTRACT

An image processing system includes a first optical system configured to form a first optical image having a low-resolution region corresponding to an angle of view less than a first angle of view and a high-resolution region corresponding to an angle of view greater than or equal to the first angle of view, a first imaging unit configured to generate first image data by imaging the first optical image formed by the first optical system, and an image processing unit configured to generate first modified image data in which the first image data is modified.

This application is a continuation-in-part of International Patent Appln. No. PCT/JP2023/001931 filed Jan. 23, 2023.

### BACKGROUND

### Field

The present invention relates to an image processing system, a movable apparatus, an imaging system, an image processing method, a storage medium, and the like.

### Description of the Related Art

There is a system for photographing the surroundings of a movable apparatus such as a vehicle and generating a bird's-eye-view video (a bird's-eye view) when an operator controls the movable apparatus. Japanese Patent Laid-open No. 2008-283527 discloses that the surroundings of a vehicle are photographed and a bird's-eye-view video is displayed.

However, in the technology disclosed in Japanese Patent Laid-open No. 2008-283527, there is a problem that the sense of resolution of a stretched peripheral region deteriorates when a process of stretching a region distant from a camera or a peripheral region of a camera-specific image is performed.

### SUMMARY OF THE DISCLOSURE

According to an aspect of the present invention, there is provided an image processing system including: a first optical system configured to form a first optical image having a low-resolution region corresponding to an angle of view less than a first angle of view and a high-resolution region corresponding to an angle of view greater than or equal to the first angle of view; a first imaging unit configured to generate first image data by imaging the first optical image formed by the first optical system; and an image processing unit configured to generate first modified image data in which the first image data is modified.

Further features of the present disclosure will become apparent from the following description of embodiments with reference to the attached drawings.

### BRIEF DESCRIPTION OF THE DRAWINGS

FIG. 1 is a diagram showing a vehicle (for example, an automobile) and an imaging range of a camera in a first embodiment.

FIG. 2 is a functional block diagram for describing a configuration of an image processing system 100 in the first embodiment.

FIG. 3, part (A), is a diagram showing an image height y1 at each half-angle of view on a light-receiving surface of an imaging element of an optical system 1 in a contour-line pattern in the first embodiment.

FIG. 3, part (B), is a diagram showing projection characteristics representing a relationship between an image height y1 and a half-angle of view 01 of the optical system 1 in the first embodiment.

FIGS. 4A to 4C are diagrams showing the image height at each half-angle of view on the light-receiving surface of the imaging element of each optical system in the contour-line pattern.

FIG. 5 is a graph showing an example of resolution characteristics of an equidistant projection, the optical system 1, and an optical system 2 in the first embodiment.

FIG. 6 is a flowchart for describing a flow of an image processing method executed by an information processing unit 21 of the first embodiment.

FIG. 7 is a diagram for describing a virtual viewpoint and image modification of the first embodiment.

FIG. 8A is a schematic diagram showing a vehicle 10 located on a road surface and an imaging range of a camera 14 on its left side.

FIG. 8B is a schematic diagram of an image 70 acquired by the camera 14.

FIG. 9A is a diagram showing an example of an image captured by a camera 11 while the vehicle 10 is traveling.

FIG. 9B is a diagram showing an example of an image obtained by performing a coordinate conversion (modification) process of converting the image of FIG. 9A acquired by the camera 11 into a video (orthographic projection) from a virtual viewpoint directly above the vehicle.

FIG. 10A is a diagram showing an example of captured images 81a to 84a acquired by cameras 11 to 14.

FIG. 10B is a diagram showing a composite image 90 obtained by synthesizing the captured images.

FIGS. 11A to 11D are diagrams showing positional relationships between optical systems (an optical system 1 and an optical system 2) and an imaging element according to a third embodiment.

FIG. 12A is a schematic diagram showing an imaging range when a camera 11 having a positional relationship between the optical system and the imaging element shown in FIG. 11D and having the optical system 2 is arranged on a front of a vehicle 10.

FIG. 12B is a schematic diagram of image data acquired from the camera 11.

FIGS. 13A and 13B are schematic diagrams when the camera 11 is arranged on the front in the third embodiment.

FIGS. 14A and 14B are schematic diagrams showing an example in which the camera 12 having the optical system 1 is arranged on a right side of the vehicle 10 in the third embodiment.

FIGS. 15A and 15B are schematic diagrams showing an example in which a camera 14 having the optical system 1 is arranged on a left side of the vehicle 10 in the third embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### [First Embodiment]

In a first embodiment, an imaging system in which four cameras for performing a photographing process in each of the four directions around an automobile as a movable apparatus are installed and a video (bird's-eye view) for overlooking a vehicle is generated from a virtual viewpoint located directly above the vehicle will be described.

Furthermore, in the present embodiment, the visibility of the video from the virtual viewpoint can be improved by assigning a region capable of being acquired at high resolution (a high-resolution region) to a region stretched at the time of viewpoint conversion for a camera-specific image.

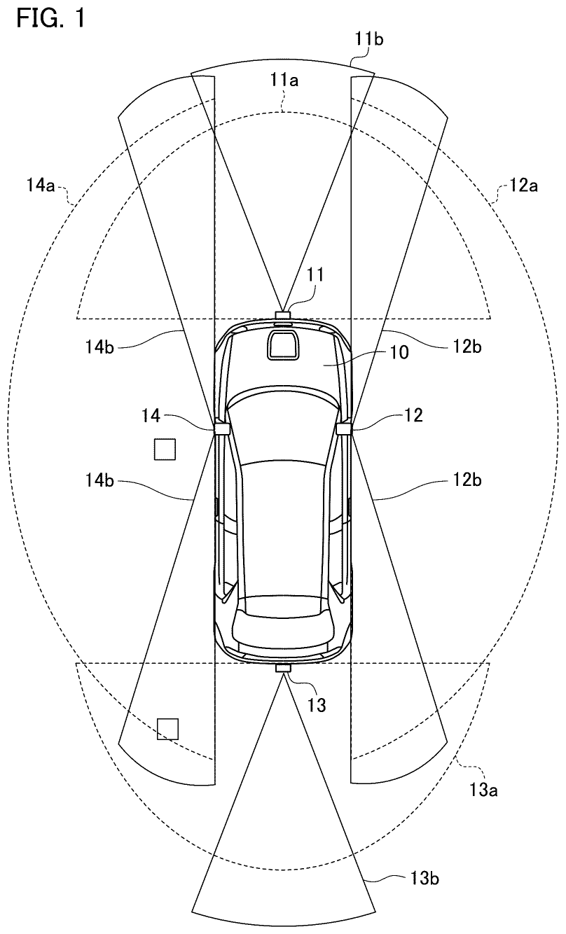

FIG. 1 is a diagram showing a vehicle (for example, an automobile) and an imaging range of a camera in the first embodiment. As shown in FIG. 1, cameras 11, 12, 13, and 14 (imaging unit) are installed at positions on the front, right, rear, and left of a vehicle 10 (movable apparatus), respectively.

The cameras 11 to 14 are imaging units each having an optical system and an imaging element. In the cameras 11 to 14, an imaging direction is set so that the imaging range includes forward, right, rearward, and left directions of the vehicle 10. Each camera has, for example, an imaging range of an angle of view of approximately 180 degrees. Also, an optical axis of the optical system provided in each of the cameras 11 to 14 is installed to be horizontal with respect to the vehicle 10 when the vehicle 10 is placed on a horizontal road surface.

Imaging ranges 11a to 14a schematically show horizontal angles of view of the cameras 11 to 14 and imaging ranges 11b to 14b schematically show high-resolution regions where an image can be acquired at high resolution in accordance with characteristics of the optical system in each camera. The cameras 11 and 13, which are front and rear cameras, can acquire a region near the optical axis at high resolution and the cameras 12 and 14, which are side cameras, can acquire a peripheral angle-of-view region away from the optical axis at high resolution.

Furthermore, the imaging range and the high-resolution region of each of the cameras 11 to 14 are actually three-dimensional ranges, but are schematically represented in a plane in FIG. 1. Also, a photographing range of each camera overlaps a photographing range of another camera adjacent thereto in a peripheral portion.

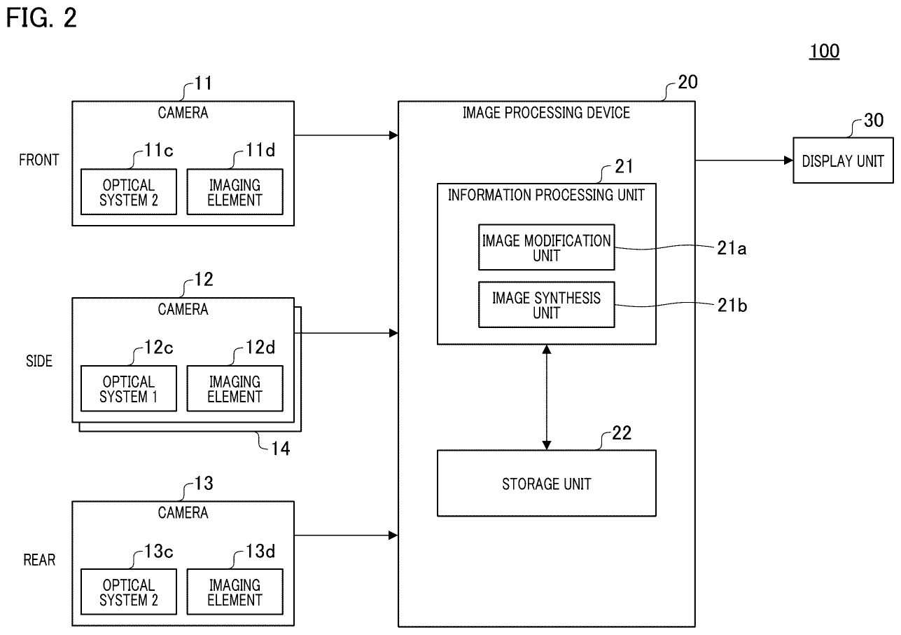

Next, FIG. 2 is a functional block diagram for describing a configuration of the image processing system 100 in the first embodiment. The image processing system 100 will be described with reference to FIG. 1. Furthermore, some of the functional blocks shown in FIG. 2 are implemented by causing a computer (not shown) included in the image processing system 100 to execute a computer program stored in a storage unit 22 as a storage medium.

Also, the functional blocks shown in FIG. 2 may not be built into the same housing, but may include separate devices connected to each other via a signal path.

In FIG. 2, the image processing system 100 is mounted in the vehicle 10 such as an automobile. The cameras 11 to 14 have imaging elements 11d to 14d configured to capture optical images and optical systems 11c to 14c configured to form optical images on light-receiving surfaces of the imaging elements (imaging elements 14c and 14d are not shown). Thereby, a surrounding situation is acquired as image data.

The optical system 1 (first optical system) provided in the cameras 12 and 14 (first imaging unit) arranged on the sides forms a high-resolution optical image in the peripheral angle-of-view region away from the optical axis and has optical characteristics for forming a low-resolution optical image in a narrow angle-of-view region around the optical axis.

The optical system 2 (second optical system) provided in the cameras 11 and 13 (the second imaging unit) arranged on the front and rear and different from the first imaging unit forms a high-resolution optical image in a narrow angle-of-view region around the optical axis. Also, the optical system 2 has optical characteristics that form a low-resolution optical image in the peripheral angle-of-view region away from the optical axis. Details of the optical systems 11c to 14c will be described below.

Each of the imaging elements 11d to 14d is, for example, a complementary metal oxide semiconductor (CMOS) image sensor or a charge-coupled device (CCD) image sensor, and outputs imaging data by photoelectrically converting an optical image. In the imaging elements 11d to 14d, for example, RGB color filters are arranged for pixels in a Bayer array. A color image can be acquired by performing a demosaicing process.

The image processing device 20 (image processing unit) includes an information processing unit 21, the storage unit 22, and various types of interfaces (not shown) for data and a power supply input/output, and includes various types of hardware. Also, the image processing device 20 is connected to the cameras 11 to 14 and outputs image data obtained by combining a plurality of image data items acquired from the cameras to a display unit 30 as a video.

The information processing unit 21 includes an image modification unit 21a and an image synthesis unit 21b. Also, for example, a system on chip (SOC), a field programmable gate array (FPGA), a central processing unit (CPU), an application-specific integrated circuit (ASIC), a digital signal processor (DSP), a graphics processing unit (GPU), a memory, and the like are provided. The CPU performs various types of controls of the entire image processing system 100 including the camera and/or the display unit by executing a computer program stored in the memory.

Furthermore, in the first embodiment, the image processing device and the camera are housed in separate housings. Also, the information processing unit 21 performs a Debayer process for image data input from each camera in accordance with a Bayer array and converts a result of the Debayer process into image data of an RGB raster format. Furthermore, image adjustments and various types of image processing such as a white balance adjustment, a gain/offset adjustment, gamma processing, color matrix processing, a lossless compression process, and a lens distortion correction process are performed.

Also, after the image modification unit 21a performs an image modification process for viewpoint conversion, the image synthesis unit 21b synthesizes a plurality of images so that the images are connected. Details will be described below.

The storage unit 22 is an information storage device such as a read-only memory (ROM) and stores information necessary for controlling the entire image processing system 100. Furthermore, the storage unit 22 may be a removable recording medium such as a hard disk or a secure digital (SD) card.

Also, the storage unit 22 stores, for example, camera information of the cameras 11 to 14, a coordinate conversion table for performing an image modification/synthesis process, and parameters for controlling the image processing system 100. Furthermore, image data generated by the information processing unit 21 may be recorded.

The camera information includes the optical characteristics of the optical system 1 and the optical system 2, the number of pixels of each of the imaging elements 11d to 14d, photoelectric conversion characteristics, gamma characteristics, sensitivity characteristics, a frame rate, image format information, mounting position coordinates in a vehicle coordinate system of the camera, and the like. Also, the camera information may include not only design values of the camera but also adjustment values that are unique values for each individual camera.

The display unit 30 includes a liquid crystal display or an organic electroluminescent (EL) display as a display panel and displays a video (image) output from the image processing device 20. Thereby, a user can ascertain the surroundings of the vehicle. Furthermore, the number of display units is not limited to one. Two or more display units may output patterns with different viewpoints of composite images, a plurality of images acquired from cameras, and other information indications to each display unit.

Next, optical characteristics of the optical system 1 and the optical system 2 provided in the cameras 11 to 14 will be described in detail.

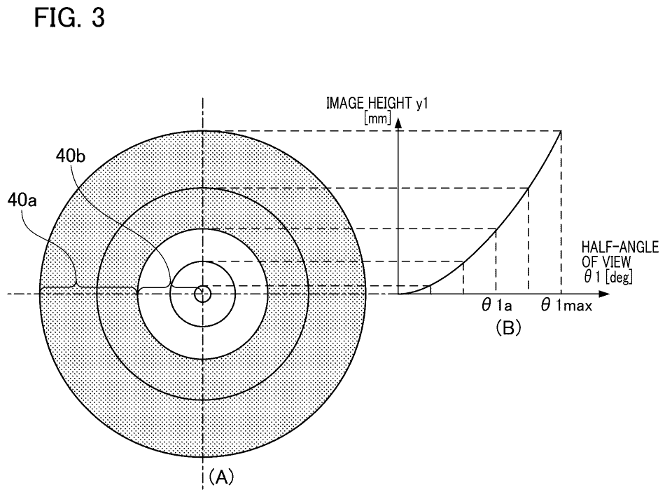

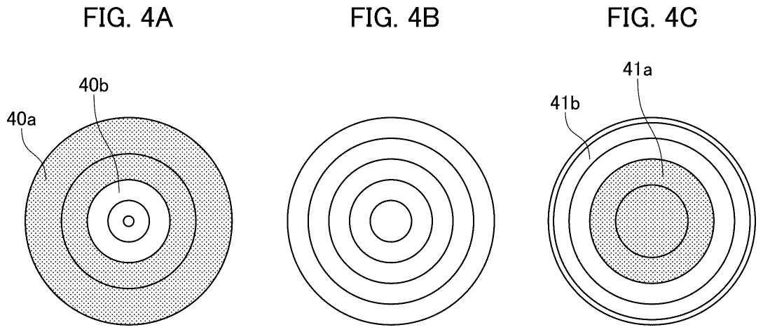

First, the optical characteristics of the optical system 1 and the optical system 2 will be described with reference to FIGS. 3 and 4. In the first embodiment, it is assumed that the cameras 12 and 14 have optical systems 1 having the same characteristics and the cameras 11 and 13 have optical systems 2 having the same characteristics. However, the optical characteristics of the optical systems of the cameras 11 to 14 may be different from each other.

FIG. 3, part (A), is a diagram showing an image height y 1 at each half-angle of view on a light-receiving surface of the imaging element of the optical system 1 in a contour-line pattern in the first embodiment. Also, FIG. 3, part (B), is a diagram showing projection characteristics indicating a relationship between the image height y1 and the half-angle of view θ1 of the optical system 1 in the first embodiment. In FIG. 3, part (B), the horizontal axis represents a half-angle of view (an angle formed by the optical axis and an incident ray) θ1 and the vertical axis represents an image formation height (image height) y1 on the light-receiving surface (image plane) of each of the cameras 12 and 14.

FIGS. 4A to 4C are diagrams showing the image height at each half-angle of view on the light-receiving surface of the imaging element of each optical system in a contour-line pattern. FIG. 4A shows the optical system 1, FIG. 4B shows an optical system of an equidistant projection method, and FIG. 4C shows the optical system 2. That is, FIGS. 3, part (A), and 4A are the same. Also, in FIGS. 3 and 4, reference signs 40a and 41a denote high-resolution regions, which are lightly shaded. Also, reference signs 40b and 41b denote low-resolution regions.

As shown in FIG. 4B, an equidistant projection type (y=fθ) lens, which is common as a fisheye lens, has uniform resolution at each image height position and has a proportional projection characteristic.

On the other hand, the optical system 1 provided in the cameras 12 and 14 is configured so that the projection characteristic y1(θ1) changes in a small region (a region near the optical axis) and a large region (a region away from the optical axis) of the half-angle of view θ1 as shown in the projection characteristics of FIG. 3, part (B). That is, when an amount of increase in an image height y1 (i.e., the number of pixels per unit angle) for the half-angle of view θ1 per unit is referred to as resolution, the resolution varies with the region.

It can be said that this local resolution is represented by a derivative value dy1(θ1)/dθ1 at the half-angle of view θ1 of the projection characteristic y1(θ1). That is, it can be said that the larger the slope of the projection characteristic y1(θ1) in FIG. 3B, the higher the resolution. Also, it can be said that the larger an interval of the image height y1 in each half-angle of view of the contour-line pattern in FIG. 3, part (A), the higher the resolution.

In the first embodiment, a region from the center formed on the light-receiving surface of the sensor when the half-angle of view θ1 is less than a predetermined half-angle of view θ1a is referred to as a low-resolution region 40b and an outward region where the half-angle of view θ1 is greater than or equal to the predetermined half-angle of view θ1a is referred to as a high-resolution region 40a. That is, the optical system 1 (first optical system) forms a first optical image having the low-resolution region 40b corresponding to an angle of view less than the first angle of view (the half-angle of view θ1a) and a high-resolution region corresponding to an angle of view greater than or equal to the first angle of view (the half-angle of view θ1a).

Also, the cameras 12 and 14 (first imaging unit) generate first image data by capturing the first optical image formed by the first optical system.

Furthermore, a value of the half-angle of view θ1a is an example for describing the optical system 1, and is not an absolute value. Also, the high-resolution region 40a corresponds to the high-resolution regions 12b and 14b in FIG. 1.

Looking at the projection characteristics of FIG. 3, part (B), it can be seen that the increase rate (slope) of the image height y1 is small in the low-resolution region 40b having a small angle of view in the vicinity of the optical axis and the increase rate (slope) increases as the angle of view gradually increases as the projection characteristics. This is a featural projection characteristic with a larger change in a slope than that of the generally known stereoscopic projection (y=2f×tan(θ/2)).

In order to implement these characteristics, it is preferable to satisfy Inequality (1) that is the following conditional formula.

$$0.2 < \frac{2 f 1 \times tan ( \frac{{θ1}_{ma x}}{2} )}{y 1 ( {θ1}_{ma x} )} < A \qquad ( 1 )$$

y1(θ1) denotes a projection characteristic indicating a relationship between the half-angle of view θ1 of the first optical system and the image height y1 at the image plane, θ1max denotes a maximum half-angle of view (an angle formed by a principal ray of the outermost axis from the optical axis), and f1 denotes a focal distance of the first optical system.

Also, A is a predetermined constant. It is preferable to determine the predetermined constant A in consideration of a balance between the resolution of the high-resolution region and the resolution of the low-resolution region. The predetermined constant A is preferably approximately 0.92 and more preferably approximately 0.8.

Above the lower limit of Inequality (1), image plane curvature, distortion, aberration, or the like deteriorates and high image quality cannot be obtained. Above the upper limit, a resolution difference between the central region and the peripheral region will decrease and the desired projection characteristics will not be implemented.

A configuration in which the optical system 2 provided in the cameras 11 and 13 has a projection characteristic having a high-resolution region near the optical axis as lightly shaded in FIG. 4C and the projection characteristic y2(θ2) is different between a region of less than a predetermined angle of view and a region of the angle of view or more is adopted.

In the optical system 2 in the first embodiment, a region near a center formed on a sensor surface when the half-angle of view θ2 is less than a predetermined half-angle of view θ2b is referred to as the high-resolution region 41a and an outward region where the half-angle of view θ2 is the predetermined half-angle of view θ2b or more is referred to as the low-resolution region 41b. That is, the optical system 2 (second optical system) forms a second optical image having the high-resolution region 41a corresponding to an angle of view less than the second angle of view (the half-angle of view θ2b) and the low-resolution region 41b corresponding to an angle of view that is a second angle of view or more.

Also, the cameras 11 and 13 (second imaging unit) generate second image data by capturing a second optical image formed by the second optical system.

Here, in FIG. 4C, a value of θ2 corresponding to the image height position at a boundary between the high-resolution region 41a and the low-resolution region 41b is denoted by θ2b and an angle of view of the high-resolution region 41a corresponds to the high-resolution regions 11b and 13b of FIG. 1.

The optical system 2 (second optical system) is configured so that the projection characteristic y2(θ2) indicating a relationship between the half-angle of view θ2 of the second optical system and the image height y2 at the image plane is larger than f2×θ2 in the high-resolution region 41a. Here, f2 denotes a focal length of the second optical system provided in the cameras 11 and 13. Also, the projection characteristic y2(θ2) in the high-resolution region is set to be different from the projection characteristic in the low-resolution region.

When θ2max denotes the maximum half-angle of view of the optical system 2, θ2b/θ2max, which is a ratio between θ2b and θ2max, is preferably greater than or equal to a predetermined lower limit value. For example, the predetermined lower limit value is preferably between 0.15 and 0.16.

Also, θ2b/θ2max, which is a ratio between θ2b and θ2max, is preferably less than or equal to a predetermined upper limit value. For example, the predetermined upper limit value is preferably between 0.25 and 0.35. For example, when θ2max is 90°, the predetermined lower limit value is 0.15, and the predetermined upper limit value is 0.35, it is preferable to set θ02b in a range of 13.5 to 31.5°.

Furthermore, the optical system 2 (second optical system) is configured to satisfy the following Inequality (2).

$$1 < \frac{2 f 2 \times sin θ {2}_{ma x}}{y 2 ( {θ2}_{ma x} )} \leq B \qquad ( 2 )$$

Here, B denotes a predetermined constant. It is possible to make the center resolution higher than that of a fisheye lens of an orthographic projection type (y=f×sinθ) having the same maximum image formation height by setting the lower limit value to 1 and it is possible to maintain high optical performance while obtaining an angle of view equivalent to that of a fisheye lens by setting the upper limit value to B. It is only necessary to determine the predetermined constant B in consideration of a balance between the resolution of the high-resolution region and the resolution of the low-resolution region. Preferably, the predetermined constant B is between 1.9 and 1.4.

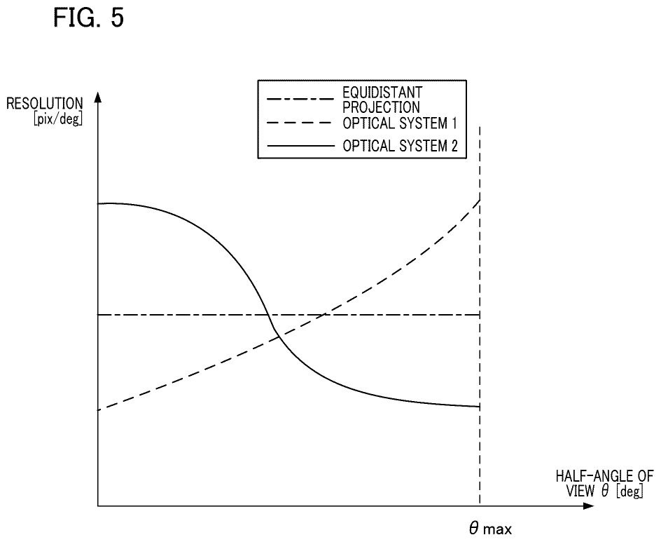

FIG. 5 is a graph showing an example of the resolution characteristics of the equidistant projection, the optical system 1, and the optical system 2 in the first embodiment. The horizontal axis represents a half-angle of view θ and the vertical axis represents resolution that is the number of pixels per unit angle of view. In the equidistant projection, the resolution is uniform at any half-angle of view, whereas the optical system 1 has the characteristic of increasing the resolution at a position where the half-angle of view is large and the optical system 2 has the characteristic of increasing the resolution at a position where the half-angle of view is small.

By using the optical system 1 and the optical system 2 having the above characteristics, for example, it is possible to acquire a high-resolution image in the high-resolution region while capturing an image with a wide angle of view equivalent to that of a fisheye lens such as 180 degrees.

That is, when a peripheral angle-of-view region away from the optical axis becomes a high-resolution region and is arranged on the side of the vehicle in the optical system 1, it is possible to acquire a high-resolution image with a small distortion in a forward/rearward direction of the vehicle.

In the optical system 2, because a region near the optical axis becomes a high-resolution region and the characteristics are approximate to the central projection method (y=f×tanθ) or the equidistant projection method (y=f×θ) having projection characteristics of a normal imaging optical system, the optical distortion is small and detailed display can be performed. Therefore, a natural sense of perspective can be obtained when nearby vehicles such as the preceding vehicle and the following vehicle are visualized and high visibility can be obtained by suppressing the deterioration of image quality.

Because the optical system 1 and the optical system 2 can obtain similar effects if they have projection characteristics y1(θ1) and y2(θ2) that satisfy the conditions of Inequalities (1) and (2), the optical system 1 and the optical system 2 of the first embodiment are not limited to the projection characteristics shown in FIGS. 3 to 5.

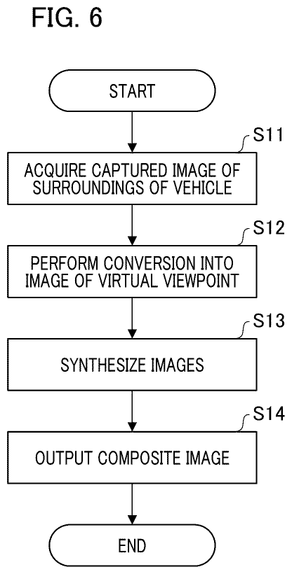

FIG. 6 is a flowchart for describing a flow of an image processing method executed by the information processing unit 21 of the first embodiment. Content of processes executed by the image modification unit 21a and the image synthesis unit 21b will also be described using the processing flow of FIG. 6. The processing flow of FIG. 6 is controlled on a frame-by-frame basis, for example, when the CPU provided inside of the information processing unit 21 executes a computer program in a memory.

When the image processing system 100 is powered on, a user's manipulation, a change in a traveling state, or the like is used as a trigger and the processing flow of FIG. 6 starts.

In step S11, the information processing unit 21 acquires image data in the four directions of FIG. 1 of the vehicle 10 captured by the cameras 11 to 14. Imaging processes of the cameras 11 to 14 are performed simultaneously (synchronously). That is, a first imaging step of generating first image data by capturing the first optical image and the second imaging step of generating second image data by capturing the second optical image are performed synchronously.

In step S12, the information processing unit 21 performs an image modification process of converting the acquired image data into an image from a virtual viewpoint. That is, an image processing step of modifying the first image data and the second image data to generate first modified image data and second modified image data is performed.

At this time, the image modification unit modifies images acquired from the cameras 11 to 14 on the basis of calibration data stored in the storage unit. Furthermore, a modification process may be performed on the basis of various types of parameters of a coordinate conversion table and the like based on calibration data. Content of the calibration data includes internal parameters of the camera due to an amount of lens distortion of each camera and a deviation from a position of the sensor, external parameters indicating a positional relationship between the cameras and a positional relationship relative to a vehicle, and the like.

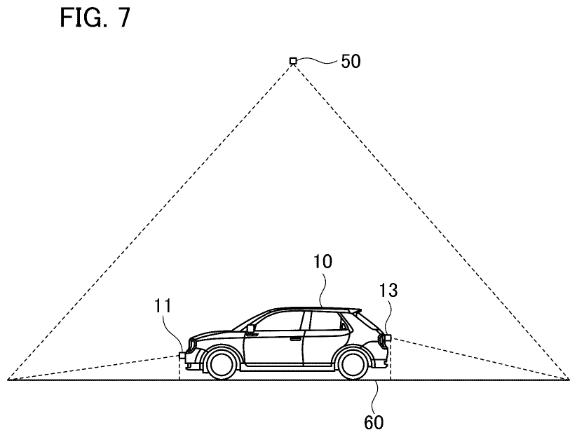

Viewpoint conversion will be described with reference to FIG. 7. FIG. 7 is a diagram for describing the virtual viewpoint and image modification in the first embodiment. In FIG. 7, the vehicle 10 is traveling on a road surface 60 and the side cameras 12 and 14 are not shown.

The cameras 11 and 13 capture images of front and rear regions and the imaging ranges of the cameras 11 and 13 include the road surface 60 around the vehicle 10. The images acquired by the cameras 11 and 13 are projected onto a position of the road surface 60 as a projection plane and a coordinate conversion (modification) process is performed for the image as if there is a virtual camera at the virtual viewpoint 50 directly above the vehicle and the projection plane is photographed. That is, the coordinate conversion process is performed for the image and a virtual viewpoint image from the virtual viewpoint is generated.

By using various types of parameters included in the calibration data, an image can be projected onto a projection plane and an image from another viewpoint can be obtained by performing the coordinate conversion process. Furthermore, it is assumed that the calibration data is calculated by calibrating the camera in advance. Also, if the virtual camera is considered as an orthographic camera, it is possible to generate an image for easily ascertaining a sense of distance without any distortion from a generated image.

Also, images can be modified in similar processes with respect to the side cameras 12 and 14 (not shown). Also, the projection plane does not have to be a flat surface resembling a road surface and may be, for example, a bowl-shaped three-dimensional shape. Also, a position of the virtual viewpoint may not be directly above the vehicle, and may be used as a viewpoint for looking at the surroundings from, for example, the oblique front or rear of the vehicle or the inside of the vehicle.

Although the image modification process has been described above, a region significantly stretched in image coordinate conversion occurs during the process.

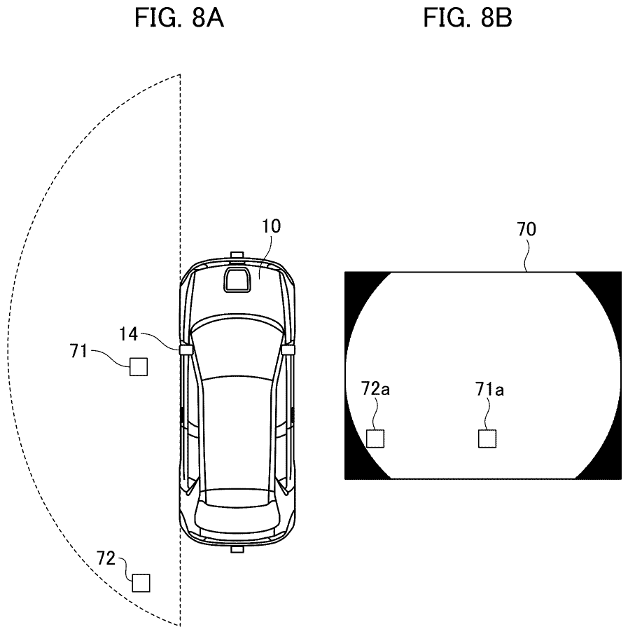

FIG. 8A is a schematic diagram showing the vehicle 10 located on the road surface and an imaging range of the camera 14 on its left side and FIG. 8B is a schematic diagram of an image 70 acquired by the camera 14. A region filled in in black in the image 70 is a region outside of the angle of view and indicates that the image has not been acquired.

Regions 71 and 72 on the road surface have the same size and are included in the imaging range of the camera 14, and are displayed, for example, at positions of regions 71a and 72a in the image 70. Here, if the optical system of the camera 14 operates in an equidistant projection method, the region 72a far from the camera 14 is distorted and displayed on the image in a small size (at low resolution).

However, when the viewpoint conversion process is performed by an orthographic virtual camera as described above, the regions 71 and 72 are stretched in the same size. At this time, because the region 72 compared to the region 71 is significantly stretched from the original image 70, the visibility deteriorates. That is, in the first embodiment, when the optical systems of the side cameras 12 and 14 operate in the equidistant projection method, the peripheral portion away from the optical axis of the acquired image is stretched in the image modification process, such that the visibility of the image after the modification may deteriorate.

On the other hand, because the side cameras 12 and 14 in the first embodiment use the optical system 1 having the characteristics shown in FIG. 3, a peripheral portion away from the optical axis can be acquired at high resolution. Therefore, even if the image is stretched, the deterioration in visibility can be suppressed as compared with that in an equidistant projection.

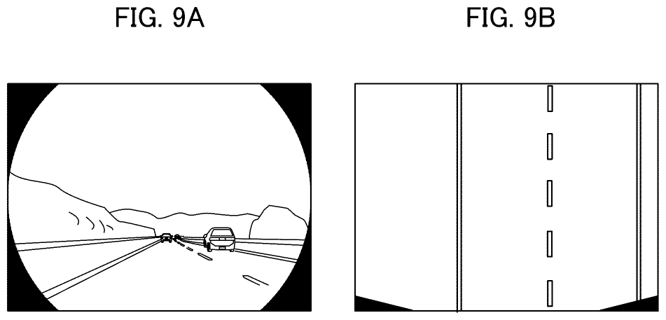

FIG. 9A is a diagram showing an example of an image captured by the camera 11 while the vehicle 10 is traveling and FIG. 9B is a diagram showing an example of an image obtained by performing a coordinate conversion (modification) process of converting the image of FIG. 9A acquired by the camera 11 into a video (orthographic projection) from a virtual viewpoint directly above the vehicle.

The image in FIG. 9A is an image captured in a state in which the vehicle 10 (host vehicle) is traveling in a left lane of a long straight road having a uniform road width. Although a distortion actually occurs due to another distortion, FIG. 9A is simplified. In FIG. 9A, the width of the road decreases due to the perspective effect as a distance from the host vehicle increases.

However, as described above, when viewpoint conversion is performed using a virtual camera of the virtual viewpoint as a positive projection, the image is stretched so that the road width is the same in both a region close to the vehicle and a region far from the vehicle as shown in FIG. 9B. In the first embodiment, when the optical systems of the cameras 11 and 13 arranged on the front and rear of the vehicle in the traveling direction operate in the equidistant projection method, an image center region near the optical axis is significantly stretched and the visibility of an image after modification deteriorates.

On the other hand, because the cameras 11 and 13 arranged on the front and rear in the first embodiment have characteristics similar to those of the optical system 2, a region near the optical axis can be acquired at high resolution. Therefore, even if the center region of the image is stretched, the deterioration in visibility can be reduced as compared with that in an equidistant projection.

Returning to the description of the flow in FIG. 6, in step S13, the information processing unit 21 synthesizes a plurality of images subjected to the conversion and modification processes in step S12. That is, second image data generated in the imaging processes of the cameras 11 and 13 (the second imaging unit) and first image data generated in the imaging processes of the cameras 12 and 14 (the first imaging unit) are modified and then synthesized to generate a composite image.

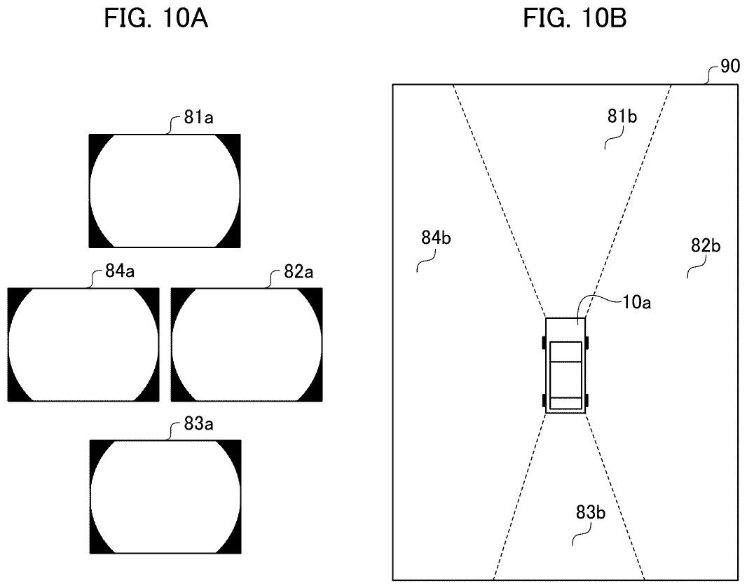

FIG. 10A is a diagram showing an example of captured images 81a to 84a acquired by the cameras 11 to 14 and FIG. 10B is a diagram showing a composite image 90 obtained by synthesizing the captured images. In step S12, the modification process based on viewpoint conversion is performed for each of the captured images 81a to 84a and then the images are synthesized in accordance with each camera position.

In this case, the images are synthesized at positions of regions 81b to 84b in the composite image 90 and an upper surface image 10a of the vehicle 10 stored in the storage unit 22 in advance is superimposed on a vehicle position.

Thereby, it is possible to create a bird's-eye-view video of the host vehicle from a virtual viewpoint and ascertain a situation around the host vehicle. Also, as shown in FIG. 1, the captured images 81a to 84a have an overlapping region when the images are synthesized because the peripheral portions of adjacent imaging regions overlap each other.

However, as indicated by the dotted lines in FIG. 10B, the composite image 90 can be displayed as a single image viewed from a virtual viewpoint by performing masking or alpha blending on images at a joint position. Also, at a superimposition position of the cameras, modification and synthesis processes can be performed using calibration data as in the case where the image is modified in step S12.

In the first embodiment, regions 82b and 84b use the optical system 1 capable of acquiring a region away from the optical axis at high resolution. Therefore, because the resolution of a region stretched in the image modification process for the regions 82b and 84b in oblique front and rear regions of the upper surface image 10a of the vehicle 10 is increased in the composite image 90, it is possible to generate a high-visuality image.

Also, in the first embodiment, the optical system 2 capable of acquiring a region near the optical axis at high resolution is used for the regions 81b and 83b. Therefore, because the resolution of a front or rear region stretched in the image modification process for the regions 81b and 83b in a region away from the upper surface image 10a of the vehicle 10 is increased in the composite image 90, it is possible to generate a high-visuality image.

Because a possibility of a collision with an obstacle is high in a traveling direction of a movable apparatus, there is a need to display it to a farther distance. Therefore, the configuration of the first embodiment is effective because it is possible to enhance the visibility of a front or rear region particularly distant from the movable apparatus.

Although the resolution of the peripheral portion away from the optical axis is low in the images 81a and 83a acquired via the optical system 2, the peripheral portion away from the optical axis has high resolution in the images 82a and 84a acquired via the optical system 1. Therefore, it is possible to compensate for the deterioration in resolution in the peripheral portion away from the optical axis of the optical system 2 by preferentially using the images 82a and 84a acquired via the optical system 1 in the overlapping region of the images when videos are synthesized.

For example, joints, which are dotted lines shown in the composite image 90, may be formed so that the regions 82b and 84b increase. That is, a synthesis process may be performed so that the regions 81b and 83b are narrowed and the regions 82b and 84b are widened. Alternatively, an alpha-blend ratio and the like may be changed between images to increase a weight of the image acquired by the optical system 1 around the joint that is the dotted line shown in the composite image 90.

Returning to FIG. 6, in step S14, the information processing unit 21 outputs a composite image in step S13 and displays the composite image on the display unit 30. Thereby, the user can confirm the video from the virtual viewpoint at high resolution.

Hereinafter, the flow of FIG. 6 is iteratively executed on a frame-by-frame basis, such that a moving image can be displayed and a position of a relative obstacle can be ascertained at high resolution.

### [Second Embodiment]

In the first embodiment, an example in which the image processing system 100 is mounted in a vehicle such as an automobile as a movable apparatus has been described. However, the movable apparatus of the first embodiment is not limited to a vehicle and may be any moving device such as a train, watercraft, aircraft, robot, or drone. Also, the image processing system 100 of the first embodiment includes one mounted in these moving devices.

Also, the first embodiment can also be applied to remotely control the movable apparatus.

Although the information processing unit 21 is mounted in the image processing device 20 of the vehicle 10 in the first embodiment, some processing by the information processing unit 21 may be performed inside the cameras 11 to 14.

In this case, the cameras 11 to 14 also include an information processing unit such as a CPU or DSP and output an image to the image processing device after various types of image processing and image adjustments are performed. Moreover, some processes by the information processing unit 21, for example, may be performed by an external server or the like via a network. In this case, for example, the cameras 11 to 14 are mounted on the vehicle 10. For example, some functions of the information processing unit 21 can be performed by an external device such as an external server or the like.

Although the storage unit 22 is included in the image processing device 20, a configuration in which a storage unit is provided in the cameras 11 to 14 and the display unit 30 may be adopted. If a configuration in which the storage unit is provided in the cameras 11 to 14 is adopted, a parameter specific to each camera can be managed in association with a camera body.

Also, some or all constituent elements included in the information processing unit 21 may be implemented by hardware. As the hardware, a dedicated circuit (ASIC), a processor (a reconfigurable processor or DSP), or the like can be used. Thereby, processing can be performed at a high speed.

Also, the image processing system 100 may include a manipulation input unit for inputting a manipulation of the user, for example, a manipulation panel including buttons and the like, a touch panel on the display unit, and the like. Thereby, an image processing device mode can be switched, a user-desired camera-specific video (image) can be switched, or a virtual viewpoint position can be switched.

Also, the image processing system 100 may be configured to provide a communication unit that performs communication in accordance with a protocol such as, for example, a controller area network (CAN) or Ethernet, and to communicate with a traveling control unit (not shown) provided inside the vehicle 10 and the like. Also, for example, information about a traveling (moving) state of the vehicle 10 such as a traveling speed, a traveling direction, a shift lever, a shift gear, a turn signal state, a direction of the vehicle 10 based on a geomagnetic sensor or the like, and the like may be acquired as control signals from the traveling control unit.

Also, in accordance with the control signal indicating the moving state, the mode of the image processing device 20 may be switched and a camera-specific video (image) may be switched or the virtual viewpoint position may be switched in accordance with a traveling state. That is, the first image data and the second image data may be modified and then synthesized to control whether or not to generate a composite image in accordance with a control signal indicating the moving state of the movable apparatus.

Specifically, for example, when a moving speed of the movable apparatus is lower than a predetermined speed (for example, lower than 10 Km/h), the first image data and the second image data may be modified and then synthesized to generate and display a composite image. Thereby, it is possible to sufficiently ascertain a surrounding situation.

On the other hand, when the moving speed of the movable apparatus is the predetermined speed or higher (for example, 10 Km/h or higher), the second image data from the camera 11, which performs an imaging in a traveling direction of the movable apparatus, may be processed and displayed. This is because it is necessary to preferentially ascertain an image of a distant position in a forward direction when the moving speed is high.

Also, the image processing system 100 may not display a video on the display unit 30 and may be configured to record a generated image on the storage unit 22 or a storage medium of an external server.

Also, in the first embodiment, an example in which the cameras 11 to 14 and the image processing device 20 are connected to acquire images has been described. However, the camera may be configured to capture an optical image having a low-resolution region and a high-resolution region with the optical system 1, the optical system 2, or the like and transmit data of the acquired image to an external image processing device 20 via, for example, a network or the like. Alternatively, the image processing device 20 may reproduce the above-described image data temporarily recorded on the recording medium to generate a composite image.

Although the image processing system has the four cameras in the first embodiment, the number of cameras provided in the image processing system is not limited to four. The number of cameras in the image processing system may be, for example, two or six. Furthermore, an effect can also be obtained in an image processing system having one or more cameras (first imaging unit) having an optical system 1 (first optical system).

That is, because there is a problem that the resolution of a peripheral portion of an imaging screen deteriorates even if the image acquired from one camera is modified, the visibility of the peripheral portion of the screen after the modification can be similarly improved by using a camera having the optical system 1. Furthermore, in the case of one camera, because it is not necessary to synthesize images, the image synthesis unit 21b is not necessary.

Also, in the first embodiment, two cameras having the optical system 1 on the side of the movable apparatus and cameras having the optical system 2 on the front and rear thereof are arranged in the image processing system 100. That is, the first imaging unit is arranged on at least one of the right and left sides of the movable apparatus in the traveling direction and the second imaging unit is arranged on at least one of the front and rear of the movable apparatus in the traveling direction.

However, the present invention is not limited to this configuration. For example, one or more cameras having the optical system 1 may be provided and another camera may have a camera configuration in which a general fisheye lens or various lenses are combined. Alternatively, one camera having the optical system 1 and one camera having the optical system 2 may be combined.

Specifically, for example, imaging regions of two cameras adjacent to each other (an imaging region of the first imaging unit and an imaging region of the second imaging unit) are arranged to overlap partially. Also, when images are synthesized to generate one continuous image, the optical system 1 is used for one camera and the optical system 2 is used for the other camera to synthesize videos. At this time, the image of the optical system 1 is preferentially used in an overlapping region of the two images.

Thereby, it is possible to synthesize videos (images) obtained by compensating for the low-resolution of the peripheral portion of the optical system 2 in the high-resolution region of the optical system 1 while using the high-resolution region near the optical axis of the optical system 2. That is, the first and second image data obtained from the first and second imaging unit are modified by the image processing unit and the display unit can display high-resolution composite data obtained by synthesizing the modified image data.

Also, in the first embodiment, the camera having the optical system 1 is used as the side camera of the movable apparatus. However, the position of the first imaging unit is not limited to the side. For example, because there is a problem that the peripheral portion of the image is stretched similarly even if the cameras having the optical system 1 are arranged on the front or rear, the embodiment is effective when the visibility of the peripheral portion of the image is desired to be increased. In this case, the first image data obtained from the first imaging unit is modified by the image processing unit and the display unit displays the modified image data.

Also, the camera arrangement direction in the first embodiment is not limited to four directions, i.e., forward, rearward, left, and right directions. The cameras may be arranged at various positions in accordance with an oblique direction or a shape of the movable apparatus. For example, in a movable apparatus such as an aircraft or a drone, one or more cameras may be arranged for capturing images in a downward direction.

Although there is an image modification process based on a coordinate conversion process of performing conversion into a video from a virtual viewpoint as the image modification unit in the first embodiment, the present invention is not limited thereto. It is only necessary for the image modification process to be a process of reducing/enlarging an image. Likewise, in this case, the visibility of the image after modification can be improved by arranging a high-resolution region of the optical system 1 or the optical system 2 in a region where the image is stretched.

Although the optical axes of the cameras 11 to 14 are arranged to be horizontal to the movable apparatus in the first embodiment, the present invention is not limited thereto. For example, the optical axis of the optical system 1 may be in a direction parallel to a vertical direction or may be arranged in an oblique direction with respect to the vertical direction.

Although the optical axis of the optical system 2 may not be in a direction horizontal to the movable apparatus, it is desirable to make an arrangement on the front or rear of the movable apparatus so that a position far from the movable apparatus is included in the high-resolution region. Because the optical system 1 can acquire an image away from the optical axis at high resolution and the optical system 2 can acquire a region near the optical axis at high resolution, it is only necessary to make an arrangement so that the high-resolution region is assigned to a region where visibility is desired to be improved after image modification in accordance with the system.

Although calibration data is stored in the storage unit 22 in advance and the images are modified and synthesized on the basis of the calibration data in the first embodiment, the calibration data may not necessarily be used. In this case, for example, the image may be modified in real time according to a user's manipulation so that it is possible to make an adjustment to a desired amount of modification.

### [Third Embodiment]

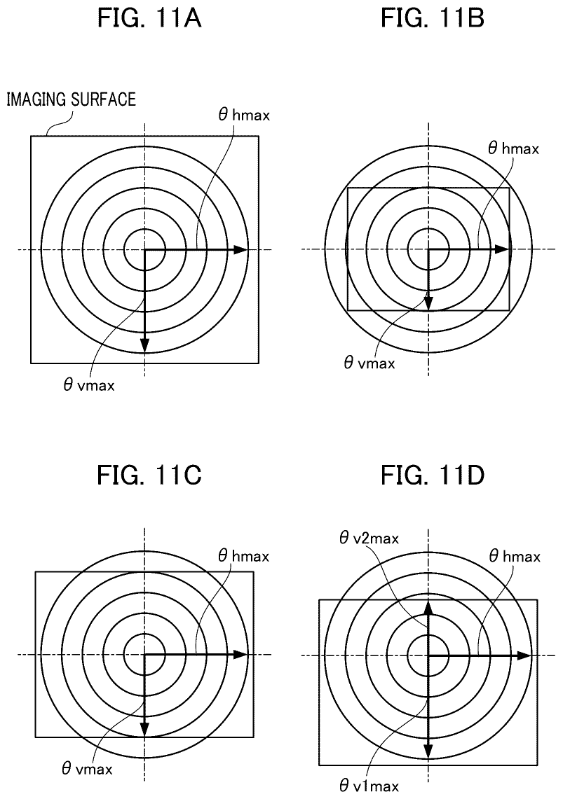

FIGS. 11A to 11D are diagrams showing positional relationships between the optical systems (the optical system 1 and the optical system 2) and the imaging element according to a third embodiment. In FIGS. 11A to 11D, each square frame represents an imaging surface (light-receiving surface) of the imaging element, a concentric circle represents a half-angle of view θ, and an outermost circle represents a maximum value θmax. When the imaging surface of the imaging element is larger than θmax, pixel data can be acquired as an image in an inner region of θmax.

On the other hand, light does not enter a range outside of θmax and pixel data cannot be acquired in this region. That is, image data can be acquired in an inner region of θmax within the imaging surface. A maximum half-angle of view at which an image can be acquired in a vertical direction on an imaging plane is denoted by θvmax and a maximum half-angle of view at which a horizontal image can be acquired is denoted by θhmax. In this case, θvmax and θhmax become the imaging range (half-angle of view) of the image data that can actually be acquired.

Because the imaging surface is square and the range of the half-angle of view θ is all contained on the imaging surface in FIG. 11A, θvmax=θhmax=θmax. For example, when θmax=90 degrees, the camera having this characteristic can capture images in a range from the camera position to a horizontal angle of view of 180 degrees and a vertical angle of view of 180 degrees.

In FIG. 11B, the range of θmax from the imaging surface is wide. θhmax<θmax and θvmax<θmax, light enters an overall region of the imaging surface, and there is no region where pixel data cannot be acquired on the imaging surface. On the other hand, the imaging range (angle of view) of the image data that can be acquired becomes narrower.

Although θhmax=θmax, θvmax<θmax, and an image can be acquired in a range of up to θmax in the horizontal direction in FIG. 11C, an image can only be acquired in a range of up to θvmax in the vertical direction. The images described in FIGS. 8 to 10 correspond to a positional relationship of FIG. 11C.

Although θhmax=θmax in the horizontal direction in FIG. 11D, the optical axis of the optical system and the center of the imaging surface are shifted in the vertical direction and the vertical symmetry is not achieved. When θvmax is not vertically symmetric, θv1max is expressed in the downward direction and θv2max is expressed in the upward direction. In this case, θv1max=θmax in FIG. 11D, but θv2max<θmax in the upward direction.

It can be considered that the same is true for the case where the optical axis is shifted in the horizontal direction. Thus, the imaging range can be changed by shifting the optical axis with respect to the center of the imaging surface. Although it is desirable to widen an angle of view in the horizontal direction and the vertical direction when θhmax=θmax and θv1max=θmax, a positional relationship of approximately θmax×0.8≤θhmax and θmax×0.8≤θv1max may be given.

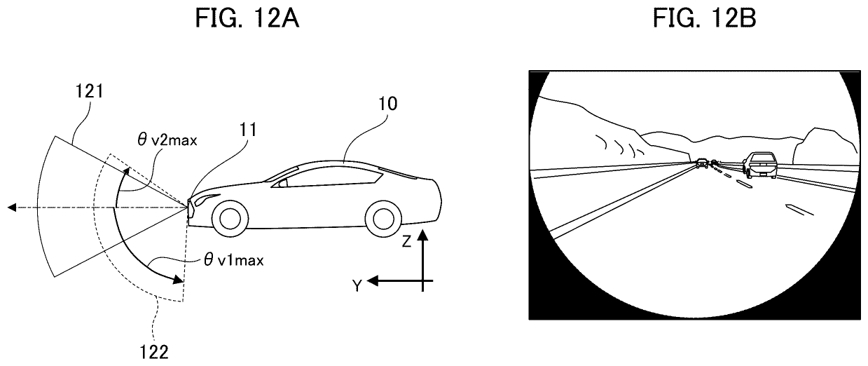

FIG. 12A is a schematic diagram showing an imaging range when the camera 11 having a positional relationship between the optical system and the imaging element shown in FIG. 11D and having the optical system 2 is arranged on the front of the vehicle 10. That is, in FIG. 12A, the forward direction of the movable apparatus is included in the high-resolution region of the second imaging unit and the second imaging unit is arranged at a position where the optical axis of the second optical system is shifted from the center of the imaging surface of the second imaging unit.

A fan-shaped solid line 121 extending from the camera 11 indicates an imaging

range of the high-resolution region of the camera 11, a fan-shaped dotted line 122 indicates an overall imaging range including the low-resolution region, and a single-dot-dashed line indicates a direction of the optical axis. In addition, an actual imaging range is expressed three-dimensionally, but it is simply displayed two-dimensionally.

FIG. 12B is a schematic diagram of image data acquired from the camera 11. A maximum range of up to the half-angle of view θmax is imaged in a horizontal direction and a vertically downward direction, but only a range of up to θv2max is imaged because θv2max<θmax in a vertically upward direction.

As shown in FIGS. 12A and 12B, the camera 11 having the optical system 2 and having the optical axis shifted in a downward direction of the vehicle with respect to the imaging surface is arranged on the vehicle 10 in the forward direction and the optical axis of the camera 11 is arranged to be horizontal to the ground in the traveling direction in front of the vehicle. Thereby, a horizontal angle of view of the camera and a vertically downward angle of view can be widened to image the road surface near the vehicle, which is the driver's blind spot. Furthermore, it is possible to image a distant region in a traveling direction in front of the vehicle 10 in the high-resolution region of the camera 11.

Although the example in which the camera is arranged on the front of the vehicle has been described in FIGS. 12A and 12B, it can be considered that the same is true for the case where the camera is arranged on the rear of the vehicle in the traveling direction. That is, when the imaging system is mounted, it is only necessary to arrange the second imaging unit on at least one of the front and rear of the movable apparatus. It is possible to image a distant region (rear region) in a direction opposite to the traveling direction of the vehicle 10 in the high-resolution region by arranging the camera having the optical system 2 on the rear of the vehicle 10.

A position where the camera is arranged is preferably arranged on the external tip (front end) of the vehicle to image the road surface in the vicinity of the vehicle, but may be arranged on an upper part of the vehicle or an inner side of the vehicle (for example, an upper part of an inner side of a windshield). In this case, it is also possible to image (photograph) a distant region in front of the vehicle at high resolution.

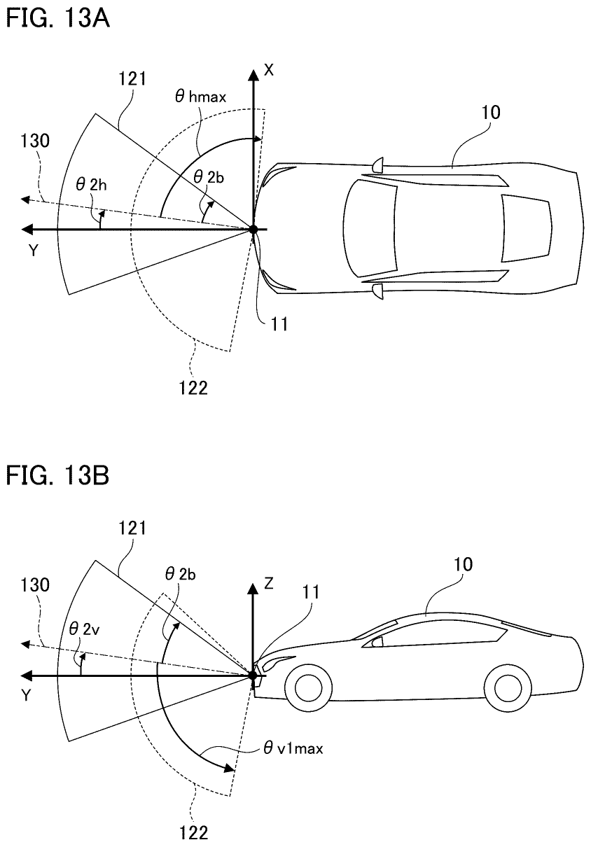

Hereinafter, an example of a suitable camera arrangement will be described with reference to the drawings. FIGS. 13A and 13B are schematic diagrams when the camera 11 is arranged at the front end of the vehicle 10 in the third embodiment. A direction parallel to the traveling direction of the vehicle is defined as a Y-axis, a direction perpendicular to the ground (horizontal plane) is defined as a Z-axis, and an axis perpendicular to a YZ plane is defined as an X-axis.

In FIGS. 13A and 13B, an absolute value of an angle formed on an XY plane by a straight line passing through an arrangement position of the camera 11 and parallel to the Y-axis and the optical axis 130 is denoted by θ2h and an absolute value of an angle formed on the YZ plane is denoted by θ2v. In this case, preferably, θ2h≤θ2b and θ2v≤θ2b. Thereby, the high-resolution region of the optical system 2 can be accommodated in the forward traveling direction.

Furthermore, when the imaging system is mounted, the second imaging unit may be arranged so that the optical axis of the second optical system is shifted in the downward direction of the movable apparatus with respect to the center of the imaging surface of the second imaging unit. If the arrangement is made as described above, it is possible to widely image the surroundings of the road surface below the movable apparatus.

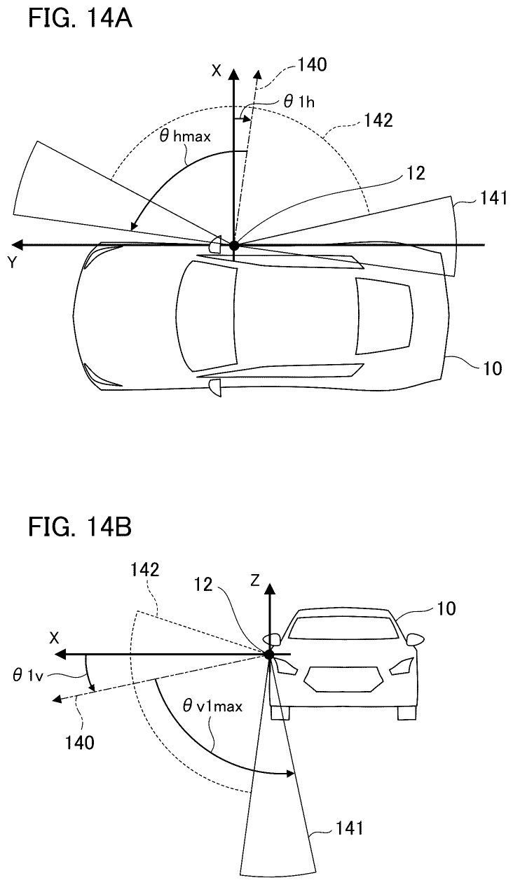

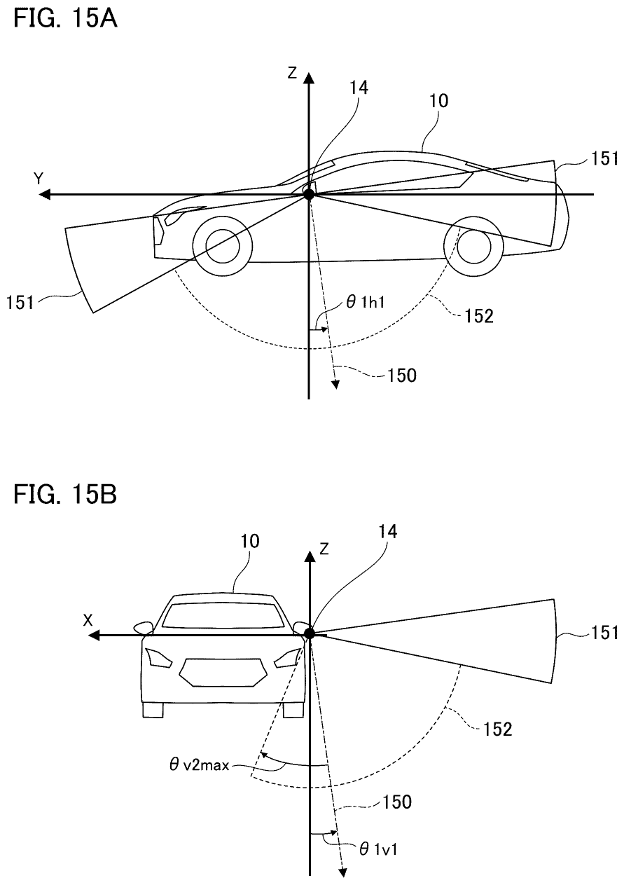

FIGS. 14A and 14B are schematic diagrams showing an example in which the camera 12 having the optical system 1 is arranged on the right side of the vehicle 10 in the third embodiment, FIG. 14A is a top view of the vehicle 10, and FIG. 14B is a front view of the vehicle 10. Also, FIGS. 15A and 15B are schematic diagrams showing an example in which the camera 14 having the optical system 1 is arranged on the left side of the vehicle 10 in the third embodiment, FIG. 15A is a left side view of the vehicle 10, and FIG. 15B is a front view of the vehicle 10.

As shown in FIGS. 14A, 14B, 15A, and 15B, an imaging system is mounted and the first imaging unit is arranged on at least one of the right side and the left side of the movable apparatus in the present embodiment.

In the cameras 12 and 14, the optical axis 140 is shifted from the center of the imaging surface as shown in FIG. 11D. A fan-shaped solid line 141 extending from the camera 12 or 14 indicates an imaging range of the high-resolution region of the camera 12 or 14, a fan-shaped dotted line indicates an imaging range of the low-resolution region, and a single-point-dashed line indicates a direction of the optical axis 140.

In FIG. 14A, an absolute value of an angle formed on the XY plane by a straight line passing through the arrangement position of the camera 12 and parallel to the X-axis and the optical axis 140 is denoted by θ1h. In this case, preferably, the value of θ1h is near 0°, i.e., the optical axis is directed perpendicular to the traveling direction of the vehicle 10. However, θ1h≤30° may be approximately set. Thereby, it is possible to image a front region and a rear region in the traveling direction in the high-resolution region of the optical system 1.

In FIG. 14B, an angle formed on the XZ plane by a straight line passing through the arrangement position of the camera 12 and parallel to the X-axis and the optical axis 140 in a downward direction of FIG. 14B is denoted by θ1v. In this case, preferably, a value of θ1v is near 0°, i.e., the optical axis is directed perpendicular to the traveling direction of the vehicle 10. However, θ1v≤(120°-θv1max) may be approximately set. Thereby, it is possible to image the road surface in the vicinity of the moving vehicle in the high-resolution region of the optical system 1.

Moreover, in the example of FIGS. 14A and 14B, the optical axis of the optical system 1 of the camera 12 is shifted from the center of the imaging surface in the downward direction (road surface direction) of the vehicle. That is, the first imaging unit is arranged at a position where the optical axis of the first optical system is shifted in the downward direction of the movable apparatus with respect to the center of the imaging surface of the first imaging unit. Thereby, a wide angle of view in the road surface direction can be obtained.

In FIG. 15A, an absolute value of an angle formed on the YZ plane by a straight line passing through the arrangement position of the camera 14 and parallel to the Z-axis and an optical axis 150 is denoted by θ1h1. In this case, the value of θ1h1 is near 0°, i.e., the optical axis is directed in the downward direction of the vehicle 10 (a road surface direction or a vertical direction). However, θ1h1≤30° may be approximately set. Thereby, it is possible to image a front region and a rear region in the traveling direction in a high-resolution region 151 of the optical system 1. Furthermore, reference sign 152 denotes a low-resolution region.

In FIG. 15B, an angle formed on the XZ plane by a straight line passing through the arrangement position of the camera 14 and parallel to the Z-axis and an optical axis 150 in the right direction of FIG. 15B is denoted by θ1v1. In this case, the value of θ1v1 is near 0°, i.e., the optical axis is directed in the downward direction of the vehicle 10 (a road surface direction or a vertical direction). However, the value of θ1v1 may be increased and the optical axis may be tilted. Thereby, it is possible to image a distant region on the side of the vehicle in the high-resolution region 151 of the optical system 1.

Moreover, in the example of FIG. 15, the optical axis 150 of the optical system 1 of the camera 14 is shifted from the center of the imaging surface in a direction away from the vehicle body (a direction away from the side of the vehicle 10). That is, in the first imaging unit, the optical axis of the first optical system is shifted in a direction away from the main body of the movable apparatus with respect to the center of the imaging surface of the first imaging unit. Thereby, it is possible to widen an angle of view for a region far from the vehicle.

Although an example in which the arrangement of the cameras 12 and 14 on the right and left sides is changed has been described above, the same arrangement may be used or only one camera may be used. Although an example in which two cameras having the optical system 1 on both sides and two cameras having the optical system 2 on the front and rear are arranged has been described, it is only necessary to have two cameras having the optical system 1 and the optical system 2, respectively.

In addition, a combination with a fisheye camera of a general projection method such as an equidistant projection may be made. Although a suitable shift position of the optical axis and the imaging surface has been described, the shift may not be made.

Although the arrangement of the cameras having the optical system 1 and the optical system 2 has been described, the present invention is not limited thereto. It is only necessary to arrange the high-resolution regions of the optical system 1 and the optical system 2 in a region of interest of a system or it is only necessary to arrange the camera having the optical system 2 on the front or rear of the vehicle and arrange the camera having the optical system 1 on the side of the vehicle. Also, the high-resolution regions of the optical system 1 and the optical system 2 are preferably arranged to overlap so that the front and rear regions can be imaged in their high-resolution regions.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing system through a network or various storage media. Then, a computer (or a CPU, an MPU, or the like) of the image processing system may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of prior-filed Japanese Patent Application No. 2022-010443, filed on Jan. 26, 2022, and Japanese Patent Application No. 2023-001011, filed on Jan. 6, 2023. Moreover, the content of the above Japanese patent applications is incorporated herein by reference in their entirety.

What is claimed is:

1. An image processing system comprising:
a first optical system configured to form a first optical image having a low-resolution region corresponding to an angle of view less than a first angle of view and a high-resolution region corresponding to an angle of view greater than or equal to the first angle of view;
one or more memories storing instructions; and
one or more processors executing the instructions to:
generate first image data by imaging the first optical image formed by the first optical system; and
generate first modified image data in which the first image data is modified.

2. The image processing system according to claim 1, wherein the one or more processors further executing the instructions to generate a virtual viewpoint image from a virtual viewpoint by performing a coordinate conversion process for an image.

3. The image processing system according to claim 1, wherein, when y1(θ1) denotes a projection characteristic indicating a relationship between a half-angle of view θ1 of the first optical system and an image height y1 at an image plane, θ1max denotes a maximum half-angle of view provided in the first optical system, f1 denotes a focal distance of the first optical system, and A denotes a predetermined integer, the following Inequality (1) is satisfied.
$$0.2 < \frac{2 f 1 \times tan ( \frac{{θ1}_{ma x}}{2} )}{y 1 ( {θ1}_{ma x} )} < A \qquad ( 1 )$$

4. The image processing system according to claim 1, comprising a second imaging unit different from the first imaging unit, wherein the one or more processors further executing the instructions to generate a composite image by modifying and then synthesizing the first image data and the second image data generated by the second imaging unit.

5. The image processing system according to claim 4, wherein an imaging region of the first imaging unit and an imaging region of the second imaging unit are arranged to overlap partially.

6. The image processing system according to claim 4, further comprising a second optical system configured to form a second optical image with respect to the second imaging unit, wherein the second optical image has a high-resolution region corresponding to an angle of view less than a second angle of view and a low-resolution region corresponding to an angle of view greater than or equal to the second angle of view.

7. The image processing system according to claim 6, wherein, when a focal distance of the second optical system is denoted by f2, a half-angle of view is denoted by θ2, an image height at an image plane is denoted by y2, and a projection characteristic indicating a relationship between the image height y2 and the half-angle of view θ2 is denoted by y2 (θ2), y2 (θ2) in the high-resolution region is greater than f2×θ2 and is different from the projection characteristic in the low-resolution region.

8. The image processing system according to claim 7, wherein, when y2(θ2) denotes a projection characteristic indicating a relationship between the half-angle of view θ2 of the second optical system and the image height y2 at the image plane, θ2max denotes a maximum half-angle of view provided in the second optical system, f2 denotes the focal distance of the second optical system, and B denotes a predetermined integer, the following Inequality (2) is satisfied.
$$1 < \frac{2 f 2 \times sin θ {2}_{ma x}}{y 2 ( {θ2}_{ma x} )} \leq B \qquad ( 2 )$$

9. A movable apparatus in which the first imaging unit of the image processing system according to claim 1 is arranged on at least one of a right side and a left side of the movable apparatus in a traveling direction.

10. A movable apparatus in which the second imaging unit of the image processing system according to claim 4 is arranged on at least one of a front and a rear of the movable apparatus in a traveling direction.

11. The movable apparatus according to claim 10, wherein the first imaging unit is arranged on at least one of a right side and a left side of the movable apparatus in the traveling direction.

12. The movable apparatus according to claim 9, further comprising a display unit configured to display modified image data modified by the image processing unit.

13. The movable apparatus according to claim 10, wherein the one or more processors further executing the instructions to control whether or not to generate a composite image by modifying and then synthesizing the first image data and the second image data in accordance with a moving state of the movable apparatus.

14. The movable apparatus according to claim 13, wherein the one or more processors further executing the instructions to generate the composite image by modifying and then synthesizing the first image data and the second image data when a moving speed of the movable apparatus is less than a predetermined speed.

15. The movable apparatus according to claim 14, wherein the one or more processors further executing the instructions to process and display the second image data from the second imaging unit that performs an imaging in the traveling direction of the movable apparatus when the moving speed of the movable apparatus is greater than or equal to the predetermined speed.

16. An imaging system comprising:
a first optical system configured to form a first optical image having a low-resolution region corresponding to an angle of view less than a first angle of view and a high-resolution region corresponding to an angle of view greater than or equal to the first angle of view;
a first imaging unit configured to generate first image data by imaging the first optical image formed by the first optical system;
a second imaging unit different from the first imaging unit; and
a second optical system configured to form a second optical image with respect to the second imaging unit,
wherein the second optical image has a high-resolution region corresponding to an angle of view less than a second angle of view and a low-resolution region corresponding to an angle of view greater than or equal to the second angle of view.

17. The imaging system according to claim 16, wherein an imaging region of the first imaging unit and an imaging region of the second imaging unit are arranged to overlap partially.

18. The imaging system according to claim 17, wherein an imaging range of the high-resolution region in the first imaging unit and an imaging range of the high-resolution region in the second imaging unit are arranged to overlap partially.

19. The imaging system according to claim 16, wherein the first imaging unit is arranged at a position where an optical axis of the first optical system is shifted from a center of an imaging surface of the first imaging unit.

20. The imaging system according to claim 16, wherein the second imaging unit is arranged at a position where an optical axis of the second optical system is shifted from a center of an imaging surface of the second imaging unit.

21. A movable apparatus in which the imaging system according to claim 16 is mounted and in which the first imaging unit is arranged on at least one of a right side and a left side of the movable apparatus.

22. A movable apparatus in which the imaging system according to claim 16 is mounted and in which the second imaging unit is arranged on at least one of a right side and a left side of the movable apparatus.

23. A movable apparatus in which the imaging system according to claim 16 is mounted and in which the second imaging unit is arranged on at least one of a front and a rear of the movable apparatus and a forward direction of the movable apparatus is included in the high-resolution region of the second imaging unit.

24. A movable apparatus in which the imaging system according to claim 16 is mounted and in which an optical axis of the first optical system in the first imaging unit is shifted in a downward direction of the movable apparatus or a direction away from a main body of the movable apparatus with respect to a center of an imaging surface of the first imaging unit.

25. A movable apparatus in which the imaging system according to claim 16 is mounted and in which an optical axis of the second optical system in the second imaging unit is shifted in a downward direction of the movable apparatus with respect to a center of an imaging surface of the second imaging unit.

26. An image processing method using an image processing system including a first optical system configured to form a first optical image having a low-resolution region corresponding to an angle of view less than a first angle of view and a high-resolution region corresponding to an angle of view greater than or equal to the first angle of view, and
a first imaging unit configured to perform a light-receiving process for the first optical image formed by the first optical system, the image processing method comprising:
generating first image data by capturing the first optical image; and
generating modified image data in which the first image data is modified.

27. A non-transitory computer-readable storage medium configured to store a computer program for an image processing system including
a first optical system configured to form a first optical image having a low-resolution region corresponding to an angle of view less than a first angle of view and a high-resolution region corresponding to an angle of view greater than or equal to the first angle of view, and
a first imaging unit configured to perform a light-receiving process for the first optical image formed by the first optical system, wherein the computer program comprises instructions for executing following processes:
generating first image data by capturing the first optical image; and
generating modified image data in which the first image data is modified.
